(19) United States
(12) Patent Application Publication
(10) Pub. No.: US 2026/0208395 A1
(43) Pub. Date: Jul. 23, 2026

(54) METHOD FOR RECYCLING POLYESTER CONTAINERS

(71) Applicant: ALPLA WERKE ALWIN LEHNER GMBH & CO. KG, Hard (AT)

(72) Inventor: Daniel GOLDENSTEIN, Lochau (AT)

(21) Appl. No.: 18/863,839

(22) PCT Filed: May 12, 2023
(86) PCT No.: PCT/EP2023/062804

§ 371 Date: Dec. 16, 2025

(30) Foreign Application Priority Data
May 13, 2022 (CH) CH000578/2022

(51) Int. Cl. B29B 11/08; B29B 9/16; B29B 13/10; B29B 17/00; B29B 17/02; B29K 67/00; C08J 11/06

(52) U.S. Cl. CPC B29B 11/08; B29B 9/16; B29B 13/10; B29B 17/0036; B29B 17/02; C08J 11/06; B29B 2009/165; B29B 2009/168; B29B 2017/0203; B29B 2017/0289; B29K 2067/003; C08J 2367/02

(57) ABSTRACT

The invention relates to a method for recycling polyester containers, in particular PET containers, comprising the following steps: (a) sorting the containers, (b) comminuting the containers into flakes, (c) washing the flakes, (d) sorting the flakes, (e) extruding the flakes including a first melt filtration, (f) granulating the melt into pellets, (g) crystallizing the pellets and (h) treating the pellets with a solid state polycondensation (SSP). Between the method steps (e) and (f), a liquid state polycondensation (LSP) (i) of the melt is applied as a further step, whereby the method has a combination of an SSP (h) and an LSP (i).

### FIELD OF THE INVENTION

The invention relates to a method for recycling polyester containers in accordance with the preamble of claim 1 and to a plant for implementing the method, as well as to recycled polyester pellets which are produced using the method.

### PRIOR ART

Previous PET recycling methods typically use SSP (solid state polycondensation) technology to decontaminate rPET or to build up the intrinsic viscosity (IV) of the recycled material. Volatile substances such as acetaldehyde can be efficiently removed and the yellowing of the resulting rPET granules is minimal. However, SSP technology can only purify non-volatile contaminants, in particular so-called precursor substances that can lead to the formation of benzene, to a certain extent, although the process takes at least 360 minutes. The best-known precursor substances are the polymers PVC and PS.

### OBJECT OF THE INVENTION

The disadvantages of the described prior art result in the object of improving the known recycling method, which uses SSP technology, in such a way that non-volatile substances are increasingly depleted or reacted and are thus considered unproblematic in the further process.

### DESCRIPTION

The stated object is achieved with a method for recycling polyester containers, in particular PET containers, by the features listed in the characterizing section of claim 1. Developments and/or advantageous alternative embodiments form the subject-matter of the dependent claims.

The invention is preferably characterized in that, between the method steps of extruding the flakes including a first melt filtration e and granulating the melt into pellets f, a liquid state polycondensation (LSP) i of the melt is applied as a further step, whereby the method has a combination of an LSP and an SSP. The decontamination in LSP (t<30 min, T>260° C.) leads to the formation reactions (=degradation reactions of e.g. PVC and PS) to benzene being further promoted in addition to the free benzene. This process actively promotes or forces the formation of benzene and depletes the precursor substances accordingly so that they are no longer found in subsequent process steps. At the same time, an initial purification of the free benzene components takes place. By means of subsequent decontamination in SSP, any remaining free benzene (boiling temperature =80° C.) and also acetaldehyde (boiling temperature=20° C.) can be removed from the granulate. The arrangement of LSP between the process steps of extruding (first melt filtration) and granulating the melt is essential, as this is the only way the process can function at all. Basically, a melt is required for the LSP reactor to operate—in this respect, extrusion is required beforehand. However, this melt may only lie within a certain viscosity spectrum so that the mass can be handled at all. If the viscosity were too high (for example after a previous SSP treatment), the melt could not be handled mechanically because it would be too viscous. If the arrangement were SSP-LSP (instead of LSP-SSP), two extrusion processes including granulate production would be required: Firstly, the flakes would have to be melted and granulated before SSP so that SSP can be carried out on the granulate. Secondly, this granulate would have to be melted again before LSP and granulated again after LSP.

The described arrangement of LSP is therefore essential so that the process can run as energy-efficiently as possible and, above all, so that investment costs can be kept low.

In a synergistic manner, in the method in accordance with the invention the SSP and LSP residence times do not add up, but can be significantly reduced. The residence times previously required for both technologies can be reduced by at least 33% (t_{LSO}<20 min; t_{SSP}<4 h), which means that the method quickly pays for itself despite the increased investment for an SSP reactor and an LSP reactor. In addition, the rPET pellets produced are almost benzene-free and therefore of significantly better quality than standard rPET granules. In this context, benzene-free does not only mean that the rPET granules contain hardly any benzene, but also that products made from these granules (e.g. PET blanks) have only slightly higher benzene levels than products made from new material.

In a particularly preferred embodiment of the invention, the intrinsic viscosity (IV) of the melt is increased by LSP (i) to up to 0.95 dl/g and a further increase in the IV of the pellets is achieved by SSP (h) to up to 1.3 dl/g. The IV can therefore be increased in two stages and the target viscosity can still be achieved with an acceptable residence time. For this specific application, the invention is characterized in that LSP i lasts a maximum of 1 h and SSP h preferably lasts 14 h and particularly preferably 10 h. With these longer residence times compared to the “standard process”, the IV can be increased to up to 1.3 dl/g. The residence time can therefore be significantly reduced compared to the processes used in accordance with the prior art to achieve a final IV of 0.8-0.9 dl/g (standard applications) and final IV of 1.2-1.3 dl/g (EBM-PET applications), making the present method efficient and therefore cost-optimized.

It has proven to be useful if the melt undergoes a second melt filtration with a mesh size of 50-150 μm after LSP (i). This allows any solid contamination that is still present or has newly formed during LSP to be removed, thus improving the optical quality of the material.

It is advisable to carry out the first melt filtration after extrusion with a mesh size of 30-100 μm, whereby solid impurities are reliably removed from the melt.

In a further preferred embodiment of the invention, LSP i before the second melt filtration lasts 10 to 15 minutes. The residence time can be kept particularly short as a further polycondensation takes place in the SSP reactor. This keeps the build-up of acetaldehyde to a minimum.

It is particularly preferred if, during LSP i, degradation reactions of benzene precursors take place in the melt, thereby preventing the formation of benzene in the pellets and polyester containers made therefrom. The formation reactions (=degradation reactions of PVC and PS) are promoted during LSP. The process actively promotes the formation of benzene in order to prevent it in subsequent process steps. For example, no benzene can form in the pre-form injection-molded from the rPET pellets because there are no longer any precursors present.

Advantageously, any benzene present in the pellets is removed during SSP h. The rPET pellets produced are therefore almost benzene-free because LSP causes benzene precursors to react to form benzene beforehand and SSP depletes all of the benzene.

A further aspect of the invention relates to a plant for implementing the method as described above. The invention is also characterized in that the plant comprises an SSP and an LSP reactor, each having a throughput of 450 to 2500 kg/h. To achieve such a throughput, the SSP reactor has a volume of approximately 11 m³. With this throughput in the continuous process, the increased space required and the increased investment costs are manageable. The investment is quickly compensated for by the shortened residence times in the two reactors and the improved quality of the rPET pellets, which can also be used in the food sector.

A further aspect of the invention relates to recycled polyester pellets, in particular rPET pellets, which are produced in accordance with the method described above. Since the pellets are almost benzene-free, they are particularly suitable for the production of food containers, in particular rPET bottles for sensitive applications such as mineral water.

Preforms can advantageously be injection molded from the recycled polyester pellets, which are then stretch blow molded into containers.

### DETAILED DESCRIPTION OF THE PRIOR ART AND AN EXEMPLARY EMBODIMENT

Known methods for producing recycled polyester pellets are based on solid state polycondensation (SSP) in a reactor. This increases the intrinsic viscosity and effectively depletes any benzene or acetaldehyde present, which comes from the return flow of polyester containers.

Some return streams for post-consumer PET recycling are contaminated with non-PET components, in particular foreign polymers such as PS and PVC. Despite all the sorting and washing steps in the recycling plant, it still happens that components (<50 ppm) of PVC and PS penetrate into the extrusion and decontamination. The degradation of these foreign polymers during the recycling process can, inter alia, cause the formation of benzene, which mainly occurs in the melt phase. The subsequent decontamination in SSP (t=6 h; T>195° C., p<10 mbar) means that free benzene (boiling temperature=80° C.) can be removed from the granulate-but no further depletion of the benzene precursors PS and PVC can take place.

Typical process values of SSP technology are:
Process flow:
   Washed flakes as input
   Extrusion (optionally including degassing)
   Melt filtration
   Crystallization
   SSP reactor (T≈195-220° C., t>6 h, p<10 mbar)
   Final granulate is available
IV build-up:
   Rather slow, typically 0.02 dl/g per hour for granules
   Starting IV before extrusion≈0.65-0.75 dl/g
   IV after extrusion≈0.60-0.72 dl/g
   IV after SSP≈0.72-0.88 dl/g (with residence time of 6-8 h)
Benzene after decontamination:
   Very low, typically <0.1 ppm in accordance with the Fraunhofer method
   Temperature is too low in SSP to degrade PVC, for example
Benzene in the preform:
   Low to high (if benzene precursors are present in the input stream)-strongly dependent on the quality of the flakes used
   Benzene typically 0.1-0.9 ppm in accordance with the Fraunhofer method
   “Precursor” substances such as PVC are broken down during the injection molding process and lead to renewed benzene formation

The SSP method has been on the market for decades and is therefore well-developed. In order to gain market share, new companies entering the recycling market developed liquid state polycondensation (LSP). LSP shows parallels to the “melt-to-resin” process used to manufacture new PET goods. LSP technology has to contend with yellowing and higher acetaldehyde levels, but the process is very fast (≈30 min).

Typical process values of LSP technology are:
Process flow:
   Washed flakes as input
   Extrusion (optionally including degassing)
   Melt filtration
   Melt pump for transport to the LSP reactor
   LSP reactor including agitator (T>265° C., p<10 mbar, t≈25-30 min)
   Melt pump for discharging the material
   Filtration
   Granulation
   Crystallization
   Post-treatment in “dealdehydization”: flow of hot air through the material (200-500 m³/h; 150-165° C.; 10-20 h)
   Final granulate is available
IV build-up:
   Very fast, up to 0.01 dl/g per minute
   Starting IV before extrusion≈0.65-0.75 dl/g
   IV after extrusion≈0.60-0.72 dl/g
   IV after LSP≈0.78-0.90 dl/g (with residence time of 25-30 min)
Yellowing:
   Is rather high due to long residence time in the melt+oxidation in dealdehydization
   Typically 2-5 in b* higher than the same material from the SSP process (depending on the quality of the flakes used)
AA values (acetaldehyde content; in accordance with the Fraunhofer method):
   4-12 ppm before dealdehydization
   0.5-4 ppm after dealdehydization (10-20 h residence time)
   Target should be <2 ppm
Benzene after decontamination:
   Very low and typically <0.1 ppm in accordance with the Fraunhofer GC method
   Long residence time in the melt phase sets certain reactions in motion, for example the degradation of PVC
Benzene in the preform:
   Very low, as all benzene precursors react in the melt reactor
   Very low benzene build-up in the injection molding process
   Typically <0.2 ppm in accordance with the Fraunhofer method

The present method comprises the following steps:

In step a, the input stream of collected polyester containers, in particular PET bottles, is sorted and in step b the sorted containers are ground into flakes. The flakes are washed in step c and sorted in step d. The flakes are then extruded in step e after they have been pre-dried. During extrusion, the flakes are filtered in a first melt filtration with a mesh size of 30-100 μm to remove foreign bodies from the melt. After the melt has been granulated into pellets (step f) and the pellets have been crystallized (step g), the pellets are transferred to an SSP reactor (step h).

Surprisingly, the method can be combined with a liquid state polycondensation (step i), whereby LSP is carried out between steps e and f. This leads to synergistic effects and the disadvantages of SSP and LSP are almost completely eliminated. The combination of steps h and i is not obvious because both the space required for an SSP reactor and an LSP reactor as well as the investment costs of both reactors are considerable. In addition, economies of scale are very small, since a large LSP or SSP reactor is less expensive than a small LSP reactor and a small SSP reactor together. From a cost perspective, a combination of SSP and LSP is pointless and return on investment would take a long time.

However, the investment in carrying out a combined SSP and LSP is worthwhile, as the necessary residence times for EBM-PET can be significantly reduced with an IV of 1.10-1.30 dl/g: In the first step in the LSP reactor, an IV increase of up to max. 0.95 dl/g is possible. The IV can be further increased to 1.10-1.30 dl/g in the SSP reactor. Instead of 24 hours in the SSP reactor, the duration of the process can be significantly shortened with a residence time of 1 hour in the LSP reactor and 10-14 hours in the SSP reactor.

Further advantages of the combined implementation of an LSP and a downstream SSP are:
The extruded melt can be transferred to the LSP reactor directly after filtration. This makes the method extremely energy efficient, as no unnecessary liquid/solid phase transition takes place.
Slightly condensed melt after LSP (residence time approx. 15 min) can be filtered a second time. Due to the shorter residence time, the IV after LSP is lower than with a conventional LSP process (residence time 25-30 min), so that less AA build-up occurs.
The granulation and crystallization of the rPET is carried out in the “semi-finished state” to allow SSP.
The IV of the granulated rPET is then further built up during SSP and volatile components, in particular AA, are purified.
The final recycled polyester, in particular rPET, can be further processed in preform injection molding, for example. The preform has a high level of purity because both benzene and benzene precursors are purified during the method by the combination of SSP and LSP. Such high-quality preforms can be stretch blow molded into containers, which can also be filled with food products.

The following values can be achieved with the present method for recycling polyester containers:
IV build-up:
   Starting IV before extrusion: 0.65-0.75 dl/g
   IV after extrusion: 0.60-0.72 dl/g
   IV after LSP: 0.74-0.85 dl/g (for standard applications such as water bottles, soft drinks, cosmetic products . . . )/0.85-0.95 dl/g (for EBM-PET applications)
   IV after SSP: 0.80-0.90 dl/g (for standard applications)/IV>1.2-1.3 dl/g (for EBM-PET applications) Yellowing:
   Comparable to previous material from the SSP process
   SSP (under vacuum or nitrogen atmosphere) instead of dealdehydization leads to less oxidative material damage
AA values:
   Comparable to previous material from the SSP process
   Lower AA build-up after LSP due to reduced intrinsic viscosity
   Increased reduction of AA by SSP due to higher temperatures and applied vacuum (compared to dealdehydization)

1. A method for recycling polyester containers, in particular PET containers, comprising the following steps:
(a) sorting the containers,
(b) comminuting the containers into flakes,
(c) washing the flakes,
(d) sorting the flakes,
(e) extruding the flakes including a first melt filtration,
(f) granulating the melt into pellets,
(g) crystallizing the pellets and
(h) treating the pellets with a solid state polycondensation (SSP)
characterized in that
between the method steps (e) and (f), a liquid state polycondensation (LSP) (i) of the melt is applied as a further step, whereby the method has a combination of an SSP (h) and an LSP (i).

2. The method according to claim 1, characterized in that the intrinsic viscosity (IV) of the melt is increased by LSP (i) to up to 0.95 dl/g and a further increase in the IV of the pellets is achieved by SSP (h) to up to 1.3 dl/g.

3. The method according to either claim 1 or claim 2, characterized in that LSP (i) lasts a maximum of 1 h and SSP (h) preferably lasts 14 h and particularly preferably 10 h.

4. The method according to any of the preceding claims, characterized in that the melt undergoes a second melt filtration with a mesh size of 50-150 μm after LSP (i).

5. The method according to any of the preceding claims, characterized in that the first melt filtration is carried out with a mesh size of 30-100 μm.

6. The method according to either claim 4 or claim 5, characterized in that LSP (i) before the second melt filtration lasts 10 to 15 minutes.

7. The method according to any of the preceding claims, characterized in that, during LSP (i), degradation reactions of benzene precursors take place in the melt, thereby minimizing the formation of benzene in the pellets and polyester containers produced therefrom.

8. The method according to any of the preceding claims, characterized in that any benzene present in the pellets is removed during SSP (h).

9. A plant for implementing the method according to any of claims 1 to 8, characterized in that the plant comprises an LSP reactor and an SSP reactor, each having a throughput of 450 to 2500 kg/h.

10. Recycled polyester pellets, in particular rPET pellets, which are produced according to any of claims 1 to 8.

11. A preform for stretch blow molding of containers, which preform is injection molded from recycled polyester pellets according to claim 10.
